(19) United States
(12) Patent Application Publication
(10) Pub. No.: US 2009/0259773 A1
(43) Pub. Date: Oct. 15, 2009

(54) NETWORK DEVICE AND METHOD FOR SETTING WORKING MODES OF LINE CARDS

(75) Inventor: CHIEN-PAN LAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/193,779

(22) Filed: Aug. 19, 2008

(30) Foreign Application Priority Data
Apr. 9, 2008 (CN) 200810300926.7

(51) Int. Cl. G06F 3/00

(52) U.S. Cl. 710/14

(57) ABSTRACT

A network device includes a plurality of line cards and a management card. Each line card has an individual identifier. The management card includes a cache, a searching module, and a communication module. The cache stores the individual identifier, a working mode, and an associated identifier for each of the plurality of line cards. The searching module is configured for receiving the individual identifier from at least one of the line cards and searching the cache to acquire a corresponding working mode and the associated identifier to the individual identifier. The communication module is configured for sending the corresponding working mode and the associated identifier to the at least one line card with the individual identifier to set a working mode for the at least one line card with the individual identifier. A method for setting working modes of line cards is also provided.

### BACKGROUND

1. Field of the Invention

Embodiments of the present disclosure relate to network communications, and particularly to a network device and a method for setting working modes of line cards.

2. Description of Related Art

Large-scale central office gateways typically include a plurality of functional line cards for executing tasks related to network communication. The line cards operate either in a redundancy mode or a non-redundancy mode. While a line card is operating under a non-redundancy mode, errors involving the line card may interrupt the task in progress. The redundancy mode includes 1+1 redundancy and N+1 redundancy.

In the 1+1 redundancy mode, there are two line cards with one line card active and an another line card in standby. The standby line card backs up and protects the active card. If the active line card becomes dysfunctional, the standby card would take over and execute the communication task in place of the active line card.

If N+1 line cards work under the N+1 redundancy mode, N line cards are active and one line card is in standby. The standby line card also backs up and protects the N active line cards. Once one active line card becomes dysfunctional, the standby line card would execute the communication task in place of the active line card. However, if another active line card also becomes dysfunctional, the communication task executed by the another line card would be interrupted.

Presently, working modes of the line cards are pre-configured and unchangeable. If a line card has been pre-configured to operate under a non-redundancy mode, errors involving this line card will interrupt the communication task in progress. If two or more line cards are pre-configured to operate under the 1+1 or N+1 redundancy modes, the standby line cards will only be in standby mode under normal circumstances, thereby reducing the efficiency of the line cards.

### SUMMARY

One embodiment of the present disclosure provides a network device. The network device includes a plurality of line cards and a management card. Each line card has an individual identifier. The management card includes a cache, a searching module, and a communication module. The cache stores the individual identifier for each of the line cards, a working mode, and an associated identifier for each of the plurality of line cards. The associated identifier of each of the plurality of line cards simultaneously acts as the individual identifier for another line card while operating under the redundancy mode. The searching module is configured for receiving the individual identifier from at least one of the line cards and searching the cache to acquire a corresponding working mode for each of the line cards and the associated identifier to the individual identifier. The communication module is configured for sending the corresponding working mode and the associated identifier to the at least one line card with the individual identifier to set a working mode for the at least one line card with the individual identifier.

Another embodiment of the present disclosure provides a method for setting working modes of a plurality of line cards. Each of the line cards has an individual identifier. The method includes the following blocks: providing a cache that stores the individual identifier, a working mode, and an associated identifier for each of the plurality of line cards, wherein the associated identifier of each of the plurality of line cards simultaneously acts as the individual identifier for another line card while operating under the redundancy mode; receiving the individual identifier from one of the line cards; searching the cache to acquire the corresponding working mode and associated identifier to the individual identifier of said one of the line card; and sending the corresponding working mode and associated identifier to said one line card with the individual identifier to set a working mode for said one line card with the individual identifier.

Other advantages and novel features of the present disclosure will become more apparent from the following detailed description of preferred embodiment when taken in conjunction with the accompanying drawings, in which:

### BRIEF DESCRIPTION OF THE DRAWINGS

FIG. 1 is a schematic diagram of functional modules of a network device in accordance with one embodiment of the present disclosure;

FIG. 2 is a flowchart of one embodiment of a method for setting working modes of line cards in accordance with the present disclosure; and

FIG. 3 is a flowchart of the method for setting working modes of line cards in accordance with a further one embodiment of the present disclosure.

### DETAILED DESCRIPTION OF CERTAIN INVENTIVE EMBODIMENTS

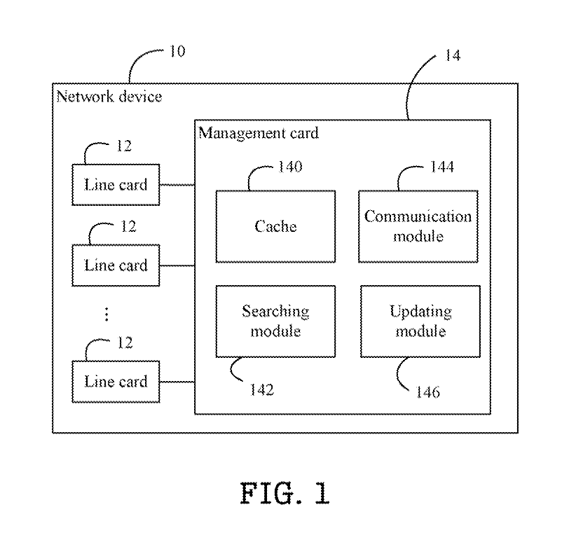

FIG. 1 is a schematic diagram of functional modules of a network device 10 in accordance with one embodiment of the present disclosure. In one embodiment, the network device 10 may be a large-scale central office network device, such as a gateway. The network device 10 includes a plurality of line cards 12 and a management card 14. The plurality of line cards 12 execute tasks related to network communication in order to provide communication service for user terminals connected to the network device 10. In one particular embodiment, the management card 14 can set working modes of the plurality of line cards 12 and dynamically change the working modes according to different requirements, thereby improving the efficiency of the network device 10.

Each line card 12 has an individual identifier. The line card 12 transmits its individual identifier to the management card 14 when inserted in the network device 10 and powered on.

The management card 14 sets working modes for the plurality of line cards 12. In one embodiment, the management card 14 includes a cache 140, a searching module 142, and a communication module 144.

The cache 140 stores the individual identifier, a working mode, and an associated identifier for each of the plurality of line cards 12. In one embodiment, the associated identifier of each line card simultaneously acts as the individual identifier for another line card while operating under the redundancy mode.

The searching module 142 is configured for receiving the individual identifier from at least one of the line cards 12 and searching the cache 140 to acquire the corresponding working mode and associated identifier to the individual identifier.

The communication module 144 is configured for sending the corresponding working mode and associated identifier to the at least one line card 12 to set a working mode for the at least one line card 12.

The line card 12 sets its working mode according to the working mode and the associated identifier from the communication module 144 and then is rebooted.

The management card 14 includes an updating module 146 that may dynamically update data stored in the cache 140. The updating module 146 is configured for receiving a mode changing command including the individual identifier, a latest working mode, a latest associated identifier of one of the line cards 12 from a manager, and for updating the working mode and the associated identifier of said one of the line cards 12 in the cache 140 with the latest working mode and the latest associated identifier in the mode changing command.

The updating module 146 is also configured for determining if one of the line cards 12 with the individual identifier in the mode changing command has been successfully connected to the management card 14. If one of the line cards 12 with the individual identifier in the mode changing command has been successfully connected to the management card 14, the management card 14 reboots one of the line cards 12 with the individual identifier and sets the working mode of one of the line cards 12 with the individual identifier according to the latest working mode and the latest associated identifier in the cache 140. If one of the line cards 12 with the individual identifier in the mode changing command has not been successfully connected, the management card 14 waits for one of the line cards 12 with the individual identifier to be successfully connected.

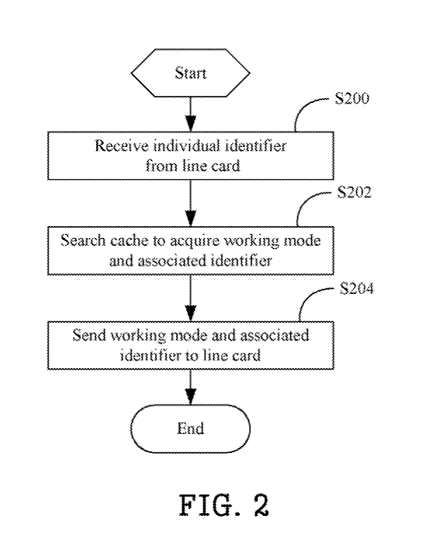

FIG. 2 is a flowchart of one embodiment of a method for setting working modes of line cards in accordance with the present disclosure. The method is executed by the functional modules depicted in FIG. 1. Only one line card 12 is used as an example to describe the method of FIG. 2 hereinafter; however, it may be understood that a plurality of line cards may be used in a substantially similar manner without departing away from the spirit of the present disclosure.

In block S200, the searching module 142 receives an individual identifier from the line card 12. In one embodiment, the line card 12 may be inserted in the network device 10 and transmits its individual identifier to the management card 14.

In block S202, the searching module 142 searches data stored in the cache 140 to acquire the corresponding working mode and associated identifier to the individual identifier.

In block S204, the communication module 144 sends the corresponding working mode and associated identifier to the line card 12 to set a working mode for the line card 12.

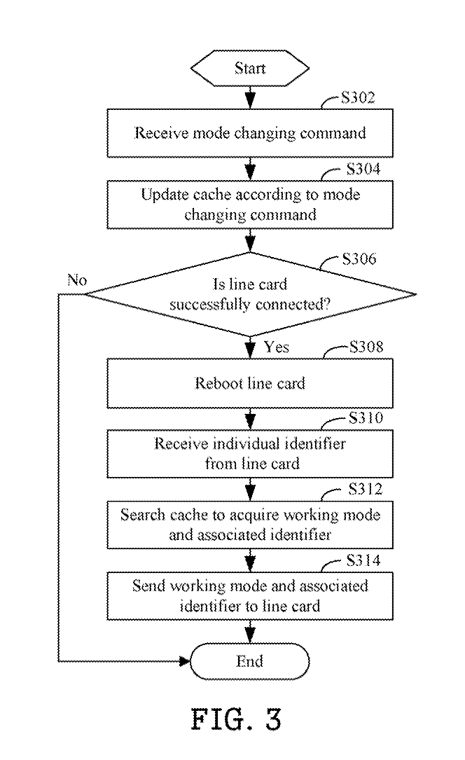

FIG. 3 is a flowchart of the method for setting working modes of line cards in accordance with another embodiment of the present disclosure. In the embodiment of FIG. 3, only one line card 12 is used as an example; however, it may be understood that a plurality of line cards may be used in a substantially similar manner without departing away from the spirit of the present disclosure.

In block S302, the updating module 146 receives a mode changing command. In one embodiment, the mode changing command includes the individual identifier, a latest working mode, and a latest associated identifier of the line card 12.

In block S304, the updating module 146 updates the working mode and the associated identifier of the line card 12 in the cache 140 with the latest working mode and associated identifier in the mode changing command.

In block S306, the updating module 146 determines if the line card 12 with the individual identifier in the mode changing command has been successfully connected to the management card 14.

If the line card 12 with the individual identifier in the mode changing command has been successfully connected, the management card 14 reboots the line card 12 as described in block S308.

In blocks S310 to S314, the management card 14 sets the working mode of the line card 12 according to the latest working mode and associated identifier in the cache 140. It may be understood that the method described in blocks S310 to S314 may be substantially the same as the method described in blocks S202 to S206, respectively, so descriptions are omitted.

The management card 14 waits for the line card 12 to be successfully connected if the line card 12 with the individual identifier in the mode changing command has not been successfully connected.

Thus, the management card 14 can set the working modes of the plurality of line cards 12 according to the working modes and the associated identifiers in the cache 140. Additionally, the management card 14 can update the working modes and the associated identifiers in the cache 140 with the latest working modes and associated identifiers in the mode changing commands, and dynamically change the working modes according to the latest working modes and associated identifiers in the cache 140. As a result, the efficiency of the network device 10 is improved.

While various embodiments and methods of the present disclosure have been described above, it should be understood that they have been presented by way of example only and not by way of limitation. Thus, the breadth and scope of the present disclosure should not be limited by the above-described one embodiments, but should be defined only in accordance with the following claims and their equivalents.

What is claimed is:

1. A network device, comprising:
a plurality of line cards, each line card having an individual identifier; and
a management card, comprising:
a cache that stores the individual identifier for each of the line cards, a working mode, and an associated identifier for each of the plurality of line cards, wherein the associated identifier of each of the plurality of line cards simultaneously acts as the individual identifier for another line card while operating under a redundancy mode;
a searching module configured for receiving the individual identifier from at least one of the line cards and searching the cache to acquire a corresponding working mode for each of the line cards and the associated identifier to the individual identifier; and
a communication module configured for sending the corresponding working mode and the associated identifier to the at least one line card with the individual identifier to set a working mode for the at least one line card with the individual identifier.

2. The network device of claim 1, wherein the management card further comprises an updating module configured for receiving a mode changing command including the individual identifier, a latest working mode, and a latest associated identifier of one of the line cards and updating the working mode and the associated identifier of said one of the line cards in the cache with the latest working mode and the latest associated identifier in the mode changing command.

3. The network device of claim 2, wherein the updating module is further configured for determining if said one of the line cards with the individual identifier in the mode changing command has been successfully connected to the management card and for rebooting said one of the line cards when said line card has been successfully connected.

4. A method for setting working modes of a plurality of line cards, each of the line cards having an individual identifier, the method comprising:
providing a cache that stores the individual identifier, a working mode, and an associated identifier for each of the plurality of line cards, wherein the associated identifier of each of the plurality of line cards simultaneously acts as the individual identifier for another line card while operating under a redundancy mode;
receiving the individual identifier from one of the line cards;
searching the cache to acquire the corresponding working mode and associated identifier to the individual identifier of said one of the line cards; and
sending the corresponding working mode and associated identifier to said one line card with the individual identifier to set a working mode for said one line card with the individual identifier.

5. The method of claim 4, further comprising:
receiving a mode changing command including the individual identifier, a latest working mode, and a latest associated identifier of said one of the line cards; and
updating the working mode and the associated identifier of said one of the line cards in the cache with the latest working mode and the latest associated identifier in the mode changing command.

6. The method of claim 5, further comprising:
determining if said one of the line cards with the individual identifier in the mode changing command has been successfully connected to the management card; and rebooting said one of the line cards when said line card has been successfully connected.
